(19) United States
(12) Patent Application Publication
(10) Pub. No.: US 2019/0234082 A1
(43) Pub. Date: Aug. 1, 2019

(54) Plaster Extruder And Applicator Device

(71) Applicant: Leonid Kraskov, Cranbourne (AU)

(72) Inventor: Leonid Kraskov, Cranbourne (AU)

(73) Assignee: Leonid Kraskov, Cranbourne (AU)

(21) Appl. No.: 16/338,012

(22) PCT Filed: Sep. 28, 2017
(86) PCT No.: PCT/AU2017/000203

§ 371 Date: Mar. 29, 2019

(30) Foreign Application Priority Data
Sep. 29, 2016 (AU) 2016903960

(51) Int. Cl. E04F 21/08; B05C 17/00; B05C 17/005

(52) U.S. Cl. CPC E04F 21/08; E04F 21/165; B05C 17/00516; B05C 17/003

(57) ABSTRACT

A plaster extruder application device includes a plaster extruder which has an end portion of a container and a plaster applicator. The end portion is adapted to contain flowable plaster compound and includes a body adapted to form the end of the container and a first set of apertures extending through the body. The end portion is also gated by at least a one-way valve which allows the compound to be drawn through the first set of apertures into the cylindrical body and therefore into the container adapted to be engaged thereto, allowing intake of compound into the container but preventing egress of the compound from the container through the first set of apertures.

### FIELD OF INVENTION

This invention relates to a plaster extruder and applicator device. More particularly, this invention relates to a universal connection to connect a plaster extruder device to a plaster applicator device.

### BACKGROUND ART

The following references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

Stud walls of buildings include corners where plasterboard meet other boards, the floor or the ceiling. These corners are finished by applying a bead of curable plaster along the length of the corner and smoothing the plaster with a plasterer's glazing tool. The bead of plaster may be applied using a plaster extruder and applicator device.

Plaster extruder and applicators have been described in which the connection or joint between the extruder and applicators is fixed. Using such devices is difficult for applying plaster to wall corners at multiple levels when the operator stays at the same vantage point or position for application.

An object of the present invention is to ameliorate the aforementioned disadvantages of the prior art or to at least provide a useful alternative thereto.

### STATEMENT OF INVENTION

The invention according to one or more aspects is as defined in the independent claims. Some optional and/or preferred features of the invention are defined in the dependent claims.

Accordingly, in one aspect of the invention there is provided:

A plaster extruder applicator device 1 is shown that comprises:

a plaster extruder in turn comprising:
an end portion of a container, adapted to contain flow able plaster compound and including;
   a body adapted to form the end of the container;
   a first set of apertures extending through the body, and gated by at least one unidirectional one-way valve which allows the compound to be drawn through the first set of apertures into the cylindrical body and therefore into the container adapted to be engaged thereto, allowing intake of compound into the container but preventing egress of the compound from the container through the first set of apertures;
   a conduit extending from the body;
   a substantially spherical feature formed with, or attached to, the conduit, the spherical feature together with the conduit including a central bore extending therethrough that terminates in a mouth through which the compound can flow and being in fluid communication with an inner cavity of the container,

a plaster applicator attachable to the plaster extruder comprising:
a concave or substantially spherical cavity adapted to removably receive the spherical feature, the plaster applicator pivotable about the spherical feature;
a retaining device to retain the spherical feature inside the spherical cavity;
at least one passage extending from the spherical cavity which allows flow of compound between the mouth and a compound delivery zone.

In another aspect, there is provided:

A plaster extruder applicator device comprising:
a plaster extruder comprising:
   an upper portion of a container, adapted to contain flow able plaster compound and having;
      a conduit extending from an upper portion body;
      a first set of apertures, through the upper portion body and/or the conduit, and gated by at least one unidirectional one-way valve which allows the compound to be drawn through the first set of apertures into the cylindrical body and therefore into the container adapted to be engaged thereto, allowing intake of compound into the container but preventing egress of the compound from the container through the first set of apertures; and
      at least one second aperture, which allows flow of the compound between the upper portion body and the conduit, and through which compound can flow into and out of the container; and
      a substantially spherical feature, which is formed with, or attached on the conduit and has a central bore through which the compound can flow, the central bore in fluid communication with an inner cavity of the container through the conduit;
   a lower portion of the container; and
   a pressurizing device which applies pressure to an inner cavity of the container to provide the impetus for the application and drawing in of the compound;
a plaster applicator comprising:
   a concave or substantially spherical cavity adapted to removably receive the spherical feature;
   a retaining device to retain the spherical feature inside the spherical cavity;
   at least one passage extending from the spherical cavity which allows flow of compound between the central bore and a compound delivery zone; and
   the compound delivery zone;

wherein, the plaster applicator pivots about the spherical feature.

The plaster applicator pivots about the universal connection. The universal connection may be oriented such that the base is located on the cylindrical cap or the plaster applicator. The cavity may be located on the other one of the cylindrical cap or the plaster applicator. The base is preferably located on the end disc and the cavity is preferably located in the plaster applicator. The retaining device may include a spring or clamping means. Preferably, the retaining device includes a spring means and is a spring retaining device. Preferably, the spring retaining device impedes the path of the spherical feature such that the spring retaining device retains the spherical feature.

Preferably, the spherical feature and spherical cavity connection between the plaster applicator and the plaster extruder allows uncured plaster to pass through the conduit for any orientation the conduit makes with the upper portion body.

The plaster applicator may be attached to the plaster extruder while compound is being drawn into the container. The compound may flow into the container through the compound delivery zone, into the passage/s extending from the spherical cavity into the conduit and through the second set of apertures into the container and the compound may also flow into the container through the first set of apertures simultaneously. The plaster applicator may be detached from the plaster extruder while compound is being drawn into the container. Preferably, the plaster applicator is attached to the plaster extruder while compound is being drawn into the container.

The plaster extruder may hold compound. A substantial amount of the compound held in the plaster extruder applicator device may be held inside the container. The container may hold a volume of compound which can be applied to the application surface while the plaster extruder applicator device is in use. The pressurizing device may include a valve, piston and piston handle. The piston may be located in the container. The pressurizing device may include a hose connected to the lower portion of the container and leading to a machine powered pressurising machine such as a compressor. The pressurising device may include a pump or compressor. The pressurising device may be manually or machine powered. Preferably, the pressurising device includes the piston and piston handle inside the container, wherein the container holds a substantial amount of the compound. Preferably, the pressurizing device is adapted to draw flow able compound into the container and to force flow able compound out of the container. The large inlet area due to multiple apertures in the first set of apertures and second apertures may allow highly viscous compound to be drawn into the container at a reasonable rate. An operator pushing and pulling on the piston handle may move the piston. The piston movement may create a pressure differential between the air outside the container and the compound/air inside the container. In this way, the piston may provide the impetus for compound being drawn into the container and pushed out of the container.

The container may include one, two or more components. Preferably, the container includes three components. The upper portion of the container may include at least one component. The lower portion of the container may include at least one component. The upper portion of the container and lower portion of the container may include separate portions of the same component. For example, the upper portion of the container may include a cap screwed onto a portion of a cylinder and the lower portion of the container which may include the other portion of the cylinder and a cap on the end of the cylinder. In addition to the above presented components of the upper portion of the container, the upper portion may also include a cap, a handle, and a tube. The lower portion of the container may also include a cap, a handle, a tube and any other connections for the pressurizing device. Preferably, the upper portion of the container includes an upper portion body screwed onto the lower portion of the container which includes a cylindrical pipe and a cap screwed on the end. The container may include seals. Preferably, the container includes seals to seal any joining components to create an air tight seal capable of retaining pressure.

The boundaries of the inner cavity of the container may change depending on the type and potential movable location of parts of the pressurising device. For example, if the pressurising device is a piston, the inner cavity may be above the piston, which is the cavity to which the piston is applying pressure. Preferably, the boundaries of the inner cavity of the container change as the pressurising device applies pressure to a changing region inside the container.

The compound may include any viscous or non-viscous plaster used in buildings. The compound may include other similar materials which may be used as substitutes for typical plaster. Preferably, the compound is a viscous plaster having a viscosity of about 10,000-about 200,000 cps, and more preferably about 100,000-about 200,000 cps at 20° C. and humidity of 50%.

The conduit may be made of a metal such as aluminium, steel, stainless steel or other typical construction metals. The conduit may be made of plastic or ceramic.

Preferably, the conduit is made of steel. Most preferably, the conduit is made of stainless steel. The conduit may include a valve. Preferably, the conduit does not include a valve. The conduit may be oriented coaxial with the plaster extruder. The conduit may be oriented at an angle to the plaster extruder. Preferably, the conduit is oriented coaxial with the plaster extruder. The conduit may be attached to the upper portion body using a weld, thread, press fit, elastic device such as a rubber seal to form a press fit, glue, bolt, or a combination thereof. The conduit may include a thread and lip to screw into the upper portion body. The conduit may be formed into the upper portion body. Preferably, the conduit screws into the upper portion body and the extent to which it screws in, is limited by the lip. The conduit may include a cylindrical portion or the whole conduit may be a cylinder. The conduit may include other cross sections such as a rectangular cross section. The conduit may be tapered along the direction coaxial with the plaster extruder, for example the conduit may take the form of a cone shape or portion of a cone shape. Preferably, the conduit includes a cylinder.

The spherical feature may include a portion of a sphere or ball. The spherical feature may form a feature on the conduit. That is the ball feature may be integrally formed with the conduit. Integral formation may take the form of a unitary construction by making the conduit from a continuous portion of material, such as metal, including steel, particularly stainless steel, Aluminium, a metal alloy, Teflon™, Acetal, or another hard and durable plastic. The spherical feature may include a sleeve which may be glued or threaded onto the conduit. The spherical feature may include an outer ring-type shape with an inner cylindrical cut out. The outer ring type shape may include a portion of a sphere. The inner cylindrical cut out may be the inner profile of the conduit. Preferably, the spherical feature forms a feature on the conduit, includes a portion of a sphere and includes an inner cylindrical cut out which is the inner profile of the conduit. The spherical feature may be made of metal such as aluminium, steel, or stainless steel. The spherical feature may be made of plastic or ceramic. The spherical feature may be made of a composite of these materials. Preferably, the spherical feature is made of steel. Most preferably, the spherical feature is made of stainless steel.

There may be one or more one-way valves. Preferably, there is one, one-way valve. A single one-way valve may cover multiple or all the apertures in the first set of apertures and therefore act as the valve for multiple apertures. The one-way valves may include a flat, flexible piece which covers apertures. The flat flexible piece may be a donut shape. The flat flexible piece may be fixed on the inner edge and free on the outer edge such that the outer edge folds up to allow compound to flow through the first set of apertures when compound is being drawn into the container and is forced flat, covering, and sealing the apertures when positive pressure is applied to the container. The flat flexible piece may be fixed on its inner edge by a screw device or by glue. Preferably, the flat flexible piece is fixed on its inner edge by a screw device.

The one-way valve may include a diaphragm valve, a ball valve, a swing valve, a clapper valve, a lift-check valve or an in-line check valve. The one-way valve may be located inside a tube or pipe. The first set of apertures may be the end of at least one pipe extending from the upper portion body wherein, the one-way valves are inside or at the end of these pipes. Preferably, the one-way valve includes a flat flexible piece which covers the apertures, in a donut shape wherein, the inner edge is fixed and the outer edge is free. The one-way valve gating the first set of apertures may be made of materials including silicone, rubber, plastic, and metal. Preferably, the one-way valve is made of a flexible plastic.

The retaining device may include one or more magnets, a spring or clamping means.

Preferably, the retaining device includes a spring means and is a spring retaining device. Preferably, the retaining device impedes the path of the spherical feature such that the retaining device removably retains the spherical feature inside the spherical cavity. The retaining device may include at least one spring loaded wire section. The retaining device may include at least one spring loaded part. The retaining device may include at least one cantilever. The retaining device may interfere with the spherical feature. The retaining device may include at least one wire. The at least one wire may include overlapping portions which overlap the profile of the spherical feature. The retaining device may include at least one section of a wire made from a single wire which, under tension, can be inserted into a channel in the plaster applicator body. The single wire may form a U-shape with bends on each end fanning outwards. The bent ends may keep the wire captive on one side of the wire and on the other side; a lip angling towards a direction normal to the channel plane may keep the other side of the wire captive. The lengths of wire between the bent ends and the lip may be substantially parallel to the channel and sit inside the channel. These wires may have bends which overlap the profile of the spherical feature. Advantageously, the overlapping portion of the wires may removably retain the spherical feature inside the spherical cavity. The retaining device may include a magnet or magnets in the spherical feature and a corresponding magnet or magnets in the spherical cavity. For example, the retaining device may include a ring-shaped magnet inserted into the central bore of the spherical feature and a corresponding ring shaped magnet inserted into the spherical cavity such that the attraction of the corresponding magnets removably retains the spherical feature inside the spherical cavity. The retaining device may include elastic materials such as elastically deformable plastic or rubber to retain the spherical feature inside the spherical cavity. For example, at least a portion of the spherical cavity may be made of elastically deformable plastic being sized or shaped with at least a portion having a smaller circumference than the spherical feature such that the spherical feature interferes with the elastic plastic when being inserted into the spherical cavity and removably retains the spherical feature in the spherical cavity. The retaining device may include a clip or sliding component to retain the spherical feature inside the spherical cavity. The retaining device may be detachable from the plaster applicator. The retaining device may form a detachable part with the spherical cavity, wherein the spherical feature is adapted to remain inside the spherical cavity and the spherical cavity is detachable from the plaster applicator through the retaining device. For example, the retaining device may include a magnet corresponding to a magnet on the plaster applicator wherein, the spherical cavity and the retaining device is detachable from the plaster applicator. Preferably, the retaining device includes at least one wire. Most preferably, the at least one wire includes overlapping portions which overlap the profile of the spherical feature.

There may be different detachable forms of the plaster applicator to suit different plaster compounds and application requirements. The number of passages extending from the spherical cavity may vary depending on factors such as the compound used.

For example, there may be 8 passages for a very thick or viscous compound and only 2 for a thin compound with a low viscosity. Preferably, there are between two and six holes, and most preferably five holes extending from the spherical cavity, particularly for highly viscous compound having a viscosity of about 100,000-about 200,000 cps at 20° C. and 50% humidity. The passages may include cylindrical holes. The passages may include slots of other cross sections. Preferably, the passages include cylindrical holes.

The compound delivery zone may include a channel or cavity which applies compound directly to an application surface. The compound delivery zone may include other devices to apply and/or smooth the compound to the application surface.

The application surface may include a wall, floor, or ceiling. The application surface may be made of plaster board, timber, tiles, concrete, plastic laminate, metal sheeting, support beams or other typical materials for use in a building. The application surface may be inside, outside or in the roof cavities of a building. The application surface may be in other areas in a building which need corners sealed or be aesthetically pleasing.

The applicator may include a body having a generally triangular construction in transverse section. The cavity may be located centrally and may extend through a broad face of the applicator body. The delivery zone may include one or more, and preferably a pair of spaced top apertures located on a ridge or apex of the body, the apertures in fluid communication with the cavity. For thick topcoat having a high viscosity, it is preferably to have more than a single top aperture, for example, at least two top apertures, because it is desirable to facilitate smooth passage of the compound through the top apertures, thereby avoiding blockages. The top apertures preferably comprise a pair of small holes each having a diameter of about 3-6 mm in area. A single top aperture with a diameter of about 5-8 mm may perform adequately.

The delivery zone may include at least one side delivery aperture extending from the cavity and through a side wall of the body, feeding into side channels making up the delivery zone and extending longitudinally of the body, the channels formed by recessed channels defined by an apex ridge and a pair of side ledges. The channels may comprise shallowly concave floors and the side ridges may be recesses below the extent of side rollers adapted to keep the side ridges spaced from the surface to which compound is to be applied.

Accordingly, in another aspect of the invention there is provided:

A method of drawing compound into the container using the plaster extruder applicator device, wherein the plaster applicator is attached to the plaster extruder, compound is drawn into the container through the first set of apertures and the apertures in the applicator, and then compound is drawn through the compound delivery zone.

This is the preferred method to operate the invention. An advantage of this method of operating the invention is that the operator of the plaster extruder applicator device doesn't need to detach the plaster applicator from the plaster extruder for drawing compound into the container. This saves time and is a cleaner process.

Accordingly, in yet another aspect of the invention there is provided:

A plaster extruder applicator device comprising:
a plaster extruder comprising:
   an upper portion of a container, adapted to contain flow able plaster compound and having;
      a concave or substantially spherical cavity adapted to removably receive a spherical feature;
      a first set of apertures through the upper portion body and gated by at least one unidirectional one-way valve which allows the compound to be drawn through the first set of apertures into the cylindrical body and therefore into the container adapted to be engaged thereto, allowing intake of compound into the container but preventing egress of the compound from the container through the first set of apertures; and
      at least one second aperture, which connects an inner cavity of the container and the spherical cavity, and through which the compound can be drawn into the container through the spherical cavity and which allows the compound to be pushed out of the container; and
   a retaining device to retain the spherical feature inside the spherical cavity;
   a lower portion of the container; and
   a pressurizing device which applies pressure to the inner cavity of the container to provide the impetus for the application and drawing in of the compound;
a plaster applicator comprising:
   a conduit extending from a plaster applicator body;
   the substantially spherical feature, which is formed with, or attached on a free end of the conduit and having a central bore through which the compound can flow;
   at least one passage extending from a base end of the conduit that permits flow of compound between the conduit and a compound delivery zone; and
   the compound delivery zone;

wherein, the plaster applicator pivots about the spherical feature.

Preferably, the spherical feature and spherical cavity connection between the plaster applicator and the plaster extruder allows uncured plaster to pass through the conduit for any orientation the conduit makes with the main plaster extruder.

The conduit may be oriented coaxial with the plaster applicator. The conduit may be oriented at an angle to the plaster applicator. Preferably, the conduit is oriented coaxial with the plaster applicator. The conduit may be attached to the plaster applicator using a weld, thread, press fit, elastic device such as a rubber seal to form a press fit, glue, bolt, or a combination thereof. The conduit may include a thread and lip to screw into the plaster applicator body. The conduit may be formed into the plaster applicator body. Preferably, the conduit screws into the plaster applicator body and the distance it screws in is limited by the lip.

The number of passages extending from the base end of the conduit may vary depending on factors such as the type of compound used. For example, there may be 8 passages for a very thick or viscous compound and only 2 for a thin compound with a low viscosity. Preferably, there are five to ten holes, and preferably eight holes extending from the base end of the conduit.

### BRIEF DESCRIPTION OF THE DRAWINGS

The invention may be better understood from the following non-limiting description of preferred embodiments, in which:

FIG. 1 is a top view of an upper portion of a container with a conduit and spherical feature attached which forms part of a plaster extruder;

FIG. 2 is a front view of the upper portion of the container;

FIG. 3 is a cross sectional front view of the upper portion of the container;

FIG. 4 is a perspective view of the upper portion of the container;

FIG. 5 is a perspective view of a plaster applicator attached to the upper portion of the container;

FIG. 6 is a front view of a plaster extruder applicator device;

FIG. 7 is an exploded perspective view of the upper portion of the container showing a one-way valve and O-ring; and

FIG. 8 is a perspective view of a piston with seals around the circumference.

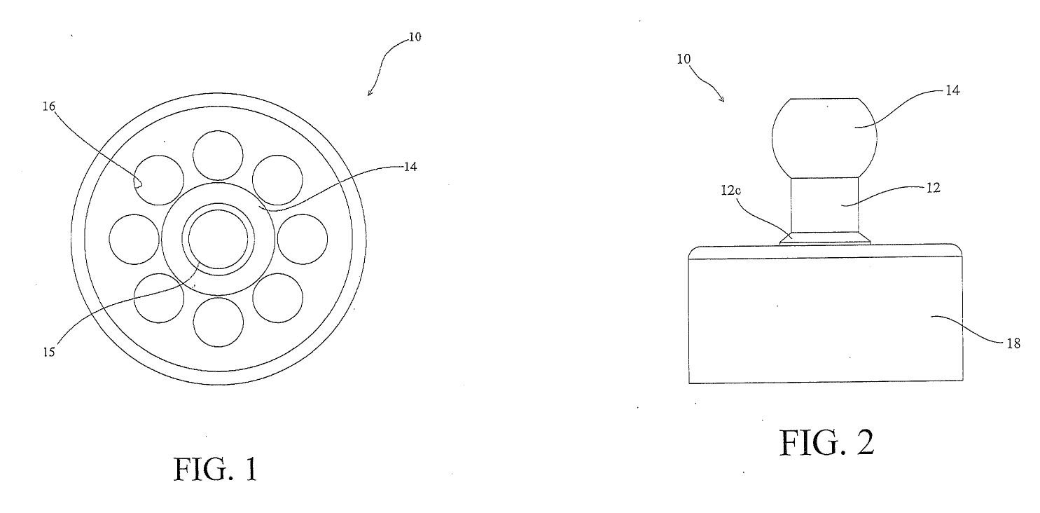

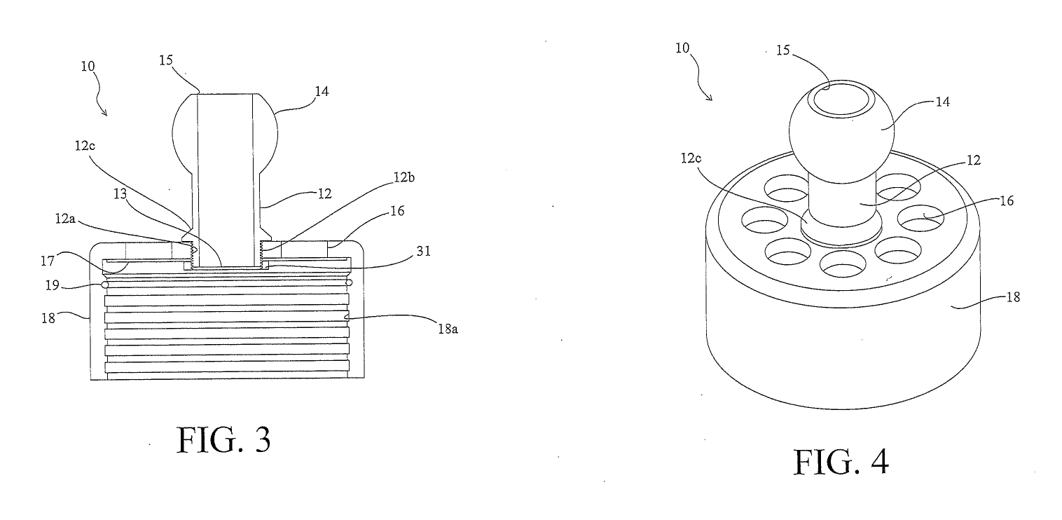

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention, except as may be recited in the claims accompanying this specification.

A plaster extruder applicator device 1 is shown that comprises a plaster extruder in turn includes an end portion 10 of a container 30, adapted to contain flowable plaster compound.

The container 30 includes:

a body 18 adapted to form the end of the container;

a first set of apertures 16 extending through the body 18, and gated by at least one unidirectional one-way valve 17 which allows the compound to be drawn through the first set of apertures 16 into the cylindrical body 18 and therefore into the container 30 adapted to be engaged thereto, allowing intake of compound into the container 30 but preventing egress of the compound from the container 30 through the first set of apertures 16;

a conduit 12 extending from the body 18; and

a substantially spherical feature 14 formed with, or attached to, the conduit 12, the spherical feature 14 together with the conduit 12 including a central bore 15 extending therethrough that terminates in a mouth through which the compound can flow and being in fluid communication with an inner cavity of the container 30.

The plaster extruder further includes a plaster applicator 20 attachable to the plaster extruder. The plaster applicator 20 includes:

a concave or substantially spherical cavity 22 adapted to removably receive the spherical feature 14, the plaster applicator 20 pivotable about the spherical feature 14;

a retaining device 24a, 24b to retain the spherical feature 14 inside the spherical cavity 22; and

at least one passage 26 extending from the spherical cavity 22 which allows flow of compound between the mouth and a compound delivery zone 28.

The at least one passage 26 may include up to seven passages 26. The at least one passage 26 may include up to two to five passages 26. Preferably, the at least one passage comprises a pair of passages 26. Preferably the at least one passage comprises a pair of passages 26 for thinner compound having a viscosity of about 10,000-100,000 cps, but a greater collective aperture area comprising more or wider holes 26 than 2 holes, for more viscous compound having a viscosity of about 100,000-200,000 at standard room temperature and humidity of about 20° C. and 50% humidity, allowing a smooth and consistent compound flow during application to the target surface.

The plaster extruder applicator device 1 may also be described as comprising the plaster extruder 50 in turn comprising: the upper portion 10 of the container 30 and the plaster applicator 20. The upper portion 10 is adapted to contain flowable plaster compound and to include the conduit 12 extending from the upper portion body 18, the first set of apertures 16 extending through the upper portion body 18 and/or the conduit 12, and gated by at least one unidirectional one-way valve 17 which allows the compound to be drawn through the first set of apertures 16 into the cylindrical body 18 and therefore into the container 30 adapted to be engaged thereto, allowing intake of compound into the container but preventing egress of the compound from the container 30 through the first set of apertures 16, at least one second aperture 13, which allows flow of the compound between the upper portion body 18 and the conduit 12, and through which compound can flow into and out of the container 30, and the substantially spherical feature 14, which is formed with, or attached to the conduit 12 through which the central bore 15 extends so that the compound can flow, the central bore 15 in fluid communication with an inner cavity of the container 30 through the conduit 12.

The container 30 includes a lower portion 32 and a pressurizing device 40 which applies pressure to an inner cavity of the container 30 to provide the impetus for the application and drawing in of the compound.

The plaster applicator 20 comprises the concave or substantially spherical cavity 22 that is adapted to removably receive the spherical feature 14, the retaining device 24a,b to retain the spherical feature 14 inside the spherical cavity 22, the at least one passage 26 extending from the spherical cavity 22 which allows flow of compound between the central bore 15 and a compound delivery zone 28. The plaster applicator 20 pivots about the spherical feature 14.

In another aspect, the plaster extruder applicator 1 may be described as being for attachment to a plaster extruder 50 having a tube container 30. The plaster extruder 50 includes the plaster extruder attachment 10 comprising:

a cylindrical cap having a cylindrical body 18 capped at a first end with an end disc and open at an opposed second end to sealably engage with the container 30, the container 30 to contain flowable plaster compound and to provide the impetus for the application of the compound.

The end disc comprises:

a first set of apertures 16 gated by at least one one-way valve 17 to permit the compound to be drawn through the first set of apertures 16 into the cylindrical body 18 and therefore into the container 30 adapted to be engaged thereto, allowing intake of compound into the container but preventing egress of the compound from the container 30 through the first set of apertures 16; and

a second set of apertures 13 which allows the compound to be drawn into the container 30, allows egress of the compound from the container 30 and leads into a conduit 12.

The plaster extruder attachment 10 further comprises a universal connection connecting the plaster extruder attachment 10 to a plaster applicator 20. The universal connection includes:

the conduit 12, extending outwardly from the end disc to space a substantially spherical feature 14 from the end disc;

the substantially spherical feature 14 formed or attached on the end of the conduit 12 and having a central bore 15 through which the compound can flow.

The plaster applicator 20 includes:

a spherical cavity 22 adapted to removably receive the spherical feature 14;

a spring retaining device (24a and 24b) to removably receive the spherical feature 14 and to ride over and engage the surface of the spherical feature 14 to retain the spherical feature 14 inside the spherical cavity 22; and

at least one passage 26 through the inner surface of the spherical cavity 22 which can receive compound from the central bore 15 of the spherical feature 14 and leads into a plaster applicator delivery zone.

The plaster applicator 20 pivots about the spherical feature 14. The plaster can pass through the conduit 12 between the plaster extruder attachment 10 and the plaster applicator 20.

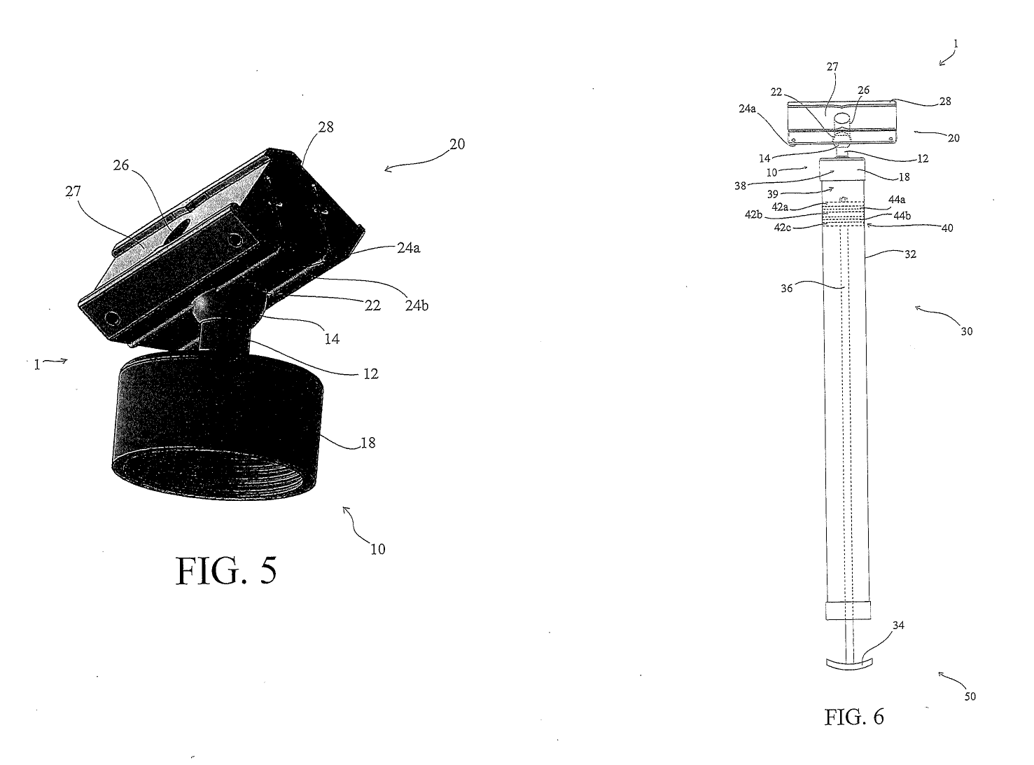

FIG. 5 shows part of the plaster extruder 50 and part of the plaster applicator 20 with a ball joint 14 holding the two together.

The part of the plaster extruder shown in FIG. 5 is the upper portion 10 of the container 30. The plaster applicator 20 also shown in FIG. 5 may also include other components not shown which may be attached to the plaster applicator 20 such as smoothing attachments and other applicator attachments. The plaster extruder 50 may be separated from the plaster applicator 20 as the spherical feature 14 may be dislodged from the spherical cavity 22. The retaining device 24a and 24b includes two wires. The two wires 24a and 24b may be formed from the same piece of wire bent in a U-shape. The two wires 24a and 24b interfere with the spherical feature 14 when the spherical feature 14 is pushed into and pulled out of the spherical cavity 22. When the spherical feature 14 is inside the spherical cavity 22, the two wires 24a and 24b apply light pressure to the spherical feature 14 such that the plaster applicator may pivot about the plaster extruder loosely while still being kept captive inside the spherical cavity 22. The extremities of the pivoting angle range are limited by contact between the plaster applicator 20 and the upper portion body 18 or the conduit 12 and the spherical cavity 22. The interference between the two wires 24a and 24b and the spherical feature 14 cause the wires 24a and 24b to bend elastically, applying an inward force to the spherical feature 14. Due to the spherical outer surface of the spherical feature 14, the reaction force from the wires 24a and 24b pushes the spherical feature 14 out of the spherical cavity 22 when the wires 24a and 24b are in contact with the front half of the spherical feature 14 (past the maximum circumference). Furthermore, the reaction force from the wires 24a and 24b pushes the spherical feature 14 further into the spherical cavity 22 when the wires 24a and 24b are in contact with the back half of the spherical feature 14 (before the maximum circumference). Therefore, a certain force is required to push the spherical feature 14 into the spherical cavity 22 and remove the spherical feature 14 from the spherical cavity 22. Therefore, the wires 24a and 24b removably retain the spherical feature 14 within the spherical cavity 22. The spherical feature 14 surface substantially matches the inner surface of the spherical cavity 22 such that insignificant plaster will exit the gap between the spherical feature 14 and the spherical cavity 22 when the spherical feature 14 is inside the spherical cavity 22 and compound is being pushed out of the compound delivery zone. Therefore, the spherical feature 14 and the spherical cavity 22 substantially form a seal.

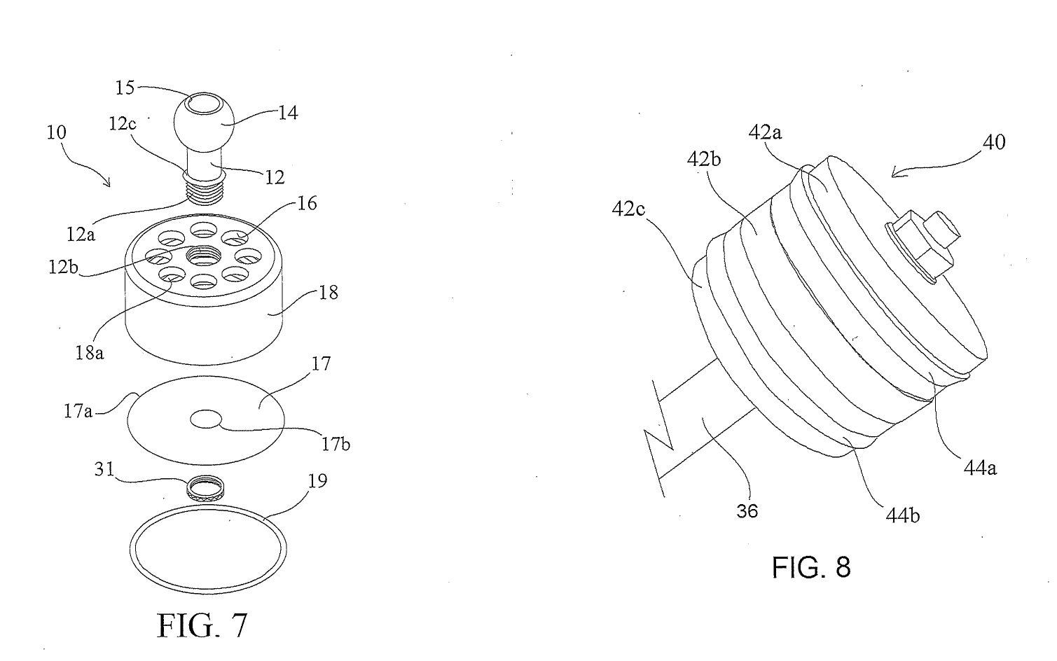

As shown in FIG. 7, the upper portion 10 of the container 30 includes the conduit 12, the spherical feature 14, the upper portion body 18, a valve gasket (one way valve) 17, a valve screw ring 31 and an O-ring 19. The conduit 12 includes a male conduit thread 12a and a lip 12c. The upper portion body 18 includes eight apertures (the group of eight apertures being the first set of apertures 16), a female conduit thread 12b and a female upper portion body thread 18a. The male conduit thread 12a screws into the female conduit thread 12b. The valve gasket 17 is inserted into the upper portion body 18 and pressed over the exposed portion male conduit thread 12a when screwed into the upper portion body 18. The valve screw ring 31 screws onto the exposed portion of the male conduit thread 12a to secure an inside edge 17b of the valve gasket 17 in place. The O-ring 19 is inserted into a groove in the upper portion body 18. The O-ring 19 forms a seal between the upper portion 10 of the container 30 and the lower portion 32 of the container 30.

The upper portion 10 of the container 30 is part of the plaster extruder 50. The plaster extruder 50 also includes the lower portion 32 of the container 30, a piston 40, a piston connecting rod 36 and a piston handle 34. The plaster extruder 50 draws the compound into the inner cavity of the container 30 by inserting the upper portion 10, with or without the plaster applicator 20 attached, into a volume of plaster with the piston 40 at the top of the container 30. The boundaries inner cavity of the container 30 change as the piston moves as the piston forms part of the boundary of the inner cavity of the container 30. It is preferable to insert the upper portion 10 with the plaster applicator 20 attached into the volume of plaster for advantages including a quicker and cleaner refilling process. The inner cavity of the container 30 has a minimum volume when the piston 40 is at the top of the container 30. The operator may then pull on the piston handle 34 to pull the piston 40 towards the bottom of the container 30, increasing the volume of the inner cavity of the container 30 and drawing plaster into the inner cavity of the container 30. Plaster is being drawn into the inner cavity of the container 30 through the central bore 15 and the first set of apertures 16 when the plaster applicator 20 is detached from the plaster extruder 50.

Plaster is being drawn into the inner cavity of the container 30 through the first set of apertures 16 and also through the compound delivery zone 28, then passing through the passages 26, then passing through the conduit 12 and finally passing through the first set of apertures 16 when the plaster applicator 20 is attached to the plaster extruder 50. As plaster is being drawn through the first set of apertures 16, the valve gasket 17 folds as the outer edge 17a of the valve gasket 17 is pulled further into the inner cavity of the container 30, allowing plaster to enter the inner cavity of the container 30 through the first set of apertures 16 and past the valve gasket 17. As the plaster generally has a high viscosity, the additional inlet cross sectional area provided by the eight holes in the first set of apertures 16 reduces the force required to pull the piston handle 34 while drawing in plaster at a reasonable rate.

As shown in FIG. 8, the piston 40 includes two piston seals 44a and 44b sandwiched between three solid discs 42a, 42b and 42c. The two piston seals 44a and 44b each have raised angled surfaces which interfere with the inner cylindrical surface of the container 30. The piston seal 44a closer to the top of the piston 40 has a raised, angled surface angling outwardly from the centre of the piston 40. The piston seal 44b closer to the bottom of the piston 40 also has a raised, angled surface angling outwardly from the centre of the piston 40. The respective angles of each of the two piston seals 44a and 44b and the raised feature of the seals ensures a reliable seal when the piston 40 is drawing in and pushing out compound.

To apply the compound to an application surface when the inner cavity of the container 30 contains compound, the plaster extruder 50 is attached to the plaster applicator 20. The plaster applicator 20 is then connected to any other devices which may assist in the application or smoothing of compound onto the application surface. The piston handle 34 is pushed such that the inner cavity of the container 30 decreases in size and compound is pushed through the conduit 12 and out the at least one passage 26. When compound is being pushed out of the inner cavity of the container 30, the valve gasket 17 is pushed flat against the top inner face of the upper portion body 18, forming a seal over the first set of apertures 16.

As the plaster extruder applicator device 1 is being used to apply compound to the application surface, the plaster applicator 20 can advantageously pivot about the plaster extruder 50, allowing easier application of the compound. The pivoting allows the respective faces of the plaster applicator 20 to remain adjacent to the corresponding faces of the application surface without the operator significantly moving the position of parts of the base of the plaster extruder 50 such as the handle 34. For example, the operator may not need to significantly change the position of the handle 34 when using the plaster extruder applicator device 1 to apply a bead of plaster to the vertical edge of two walls from a standing position.

The O-ring 19 inserted into the upper portion body 18 ensures an air tight seal between the upper portion 10 and the lower portion 32 of the container 30.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

In the present specification, terms such as “apparatus”, “means”, “device” and “member” may refer to singular or plural items and are terms intended to refer to a set of properties, functions or characteristics performed by one or more items or components having one or more parts. It is envisaged that where an “apparatus”, “means”, “device” or “member” or similar term is described as being a unitary object, then a functionally equivalent object having multiple components is considered to fall within the scope of the term, and similarly, where an “apparatus”, “assembly”, “means”, “device” or “member” is described as having multiple components, a functionally equivalent but unitary object is also considered to fall within the scope of the term, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, which will usually be apparent from the context.

It will be appreciated by those skilled in the art that many modifications and variations may be made to the methods of the invention described herein without departing from the spirit and scope of the invention.

1. A plaster extruder applicator device, said device comprising:
a plaster extruder in turn comprising:
an end portion adapted to provide the end of a container and to contain flow able plaster compound, the end portion including;
a body adapted to form the end of the container;
a first set of apertures extending through the body, and gated by at least one unidirectional one-way valve which allows the compound to be drawn through the first set of apertures into the cylindrical body and therefore into the container adapted to be engaged thereto, allowing intake of compound into the container but preventing egress of the compound from the container through the first set of apertures;
a conduit extending from the body;
a substantially spherical ball feature formed with, or attached to, the conduit, the spherical ball feature together with the conduit including a central bore extending therethrough that terminates in a mouth through which the compound can flow and being in fluid communication with an inner cavity of the container,
a plaster applicator attachable to the plaster extruder including:
a concave or substantially spherical cavity adapted to removably receive the spherical ball feature, the plaster applicator pivotable about the spherical ball feature;
a retaining device to retain the spherical ball feature inside the spherical cavity; and
at least one passage extending from the spherical cavity which allows flow of compound between the mouth and a compound delivery zone,
wherein:
the end portion operates to restrict outward flow from the container of compound through the first set of apertures, but permits the device to draw up high viscosity plastering compound through the apertures and the one-way valve where sole ingress through the central bore would be inadequate;
the passage, the cavity, the mouth, the central bore, the conduit and respectively the container, are adapted to provide continuous passage for the flow of compound into and out of the container; and
the mouth opens into the cavity and the ball feature interacts with the cavity to form a substantially universal connection.

2. A plaster extruder applicator device as claimed in claim 1, wherein the container includes a pressurizing device which applies pressure to an inner cavity of the container to provide the impetus for the application and drawing in of the compound through the compound delivery zone.

3. A plaster extruder applicator device as claimed in claim 1, wherein the plaster applicator pivots about the universal connection.

4. A plaster extruder applicator device as claimed in claim 1, wherein the universal connection is oriented such that the base is located on the cylindrical cap or the plaster applicator.

5. A plaster extruder applicator device as claimed in claim 1, wherein the cavity is located on the other one of the cylindrical cap or the plaster applicator, the base is located on the end disc and the cavity is located in the plaster applicator.

6. A plaster extruder applicator device as claimed in claim 1, wherein the retaining device includes a spring or clamping means.

7. A plaster extruder applicator device as claimed in claim 1, wherein the retaining device includes a spring means and is a spring retaining device which impedes the path of the spherical feature such that the spring retaining device retains the spherical feature.

8. A plaster extruder applicator device as claimed in claim 1, wherein the spherical feature and spherical cavity connection between the plaster applicator and the plaster extruder allows uncured plaster to pass through the conduit for any orientation of the conduit makes relative to the upper portion body.

9. A plaster extruder applicator device as claimed in claim 1, wherein the plaster applicator is attached to the plaster extruder and adapted to allow compound to be drawn into the container through the compound delivery zone

10. A plaster extruder applicator device as claimed in claim 9, wherein the plaster applicator is adapted to draw compound through one or more passages extending from the spherical cavity into the conduit and through a second set of apertures into the container and the compound may also flow into the container through the first set of apertures simultaneously.

11. A plaster extruder applicator device as claimed in claim 1, wherein the plaster applicator is adapted to be detached from the plaster extruder while compound is being drawn into the container.

12. A plaster extruder applicator device as claimed in claim 1, wherein the pressurizing device includes a valve, piston and piston handle.

13. A plaster extruder applicator device as claimed in claim 12, wherein the piston is located in the container, the pressurizing device includes a hose connected to the lower portion of the container and leads to a machine-powered pressurising machine.

14. A plaster extruder applicator device as claimed in claim 1, wherein the inlet area is large, comprising multiple apertures in the first set of apertures and in the second set of apertures, whereby to allow highly viscous compound to be drawn into the container.

15. A plaster extruder applicator device as claimed in claim 1, wherein the upper portion of the container includes a cap screwed onto a portion of a cylinder and the lower portion of the container includes the other portion of the cylinder and a cap on the end of the cylinder.

16. A plaster extruder applicator device as claimed in claim 1, wherein the spherical feature includes a portion of a sphere or ball and forms a feature on the conduit such that the ball feature is integrally formed with the conduit.

17. A plaster extruder applicator device as claimed in claim 1, wherein the spherical feature includes a sleeve which is attached to the conduit and an outer ring-type shape with an inner cylindrical cut out, the outer ring type shape including a portion of a sphere.

18. A plaster extruder applicator device as claimed in claim 17, wherein the inner cylindrical cut out may be the inner profile of the conduit, the spherical feature forming a feature on the conduit, including a portion of a sphere and an inner cylindrical cut out which is the inner profile of the conduit.

19. A plaster extruder applicator device as claimed in claim 1, further including a one-way valve covering more than one of the apertures in the first set of apertures so that the one way valve acts as the valve for multiple apertures.

20. A plaster extruder applicator device as claimed in claim 19, wherein the one-way valves include a flat, flexible donut shaped piece which covers the apertures.
